(19) United States
(12) Patent Application Publication
(10) Pub. No.: US 2019/0130416 A1
(43) Pub. Date: May 2, 2019

(54) Blockchain, notary and linket for mobile users

(71) Applicants: Wesley John Boudville, Perth (AU); Louise Marie Falevsky, Los Angeles, CA (US)

(72) Inventors: Wesley John Boudville, Perth (AU); Louise Marie Falevsky, Los Angeles, CA (US)

(73) Assignees: Wesley John Boudville, Los Angeles, CA (US); Louise Marie Falevsky, Los Angeles, CA (US)

(21) Appl. No.: 15/732,368

(22) Filed: Nov. 1, 2017

(51) Int. Cl. G06Q 30/00; G06Q 20/32; G06Q 20/10; G06Q 20/40; G06Q 20/06

(52) U.S. Cl. CPC G06Q 30/018; G06Q 20/3276; G06Q 20/1085; G06F 17/30879; G06Q 20/065; G06Q 20/3224; G06Q 20/4014

(57) ABSTRACT

Bob, with a device, is a Notary. Jane wants to upload a record of her location to a blockchain. It cannot independently verify her location if she directly uploads. Bob is considered reputable by the blockchain. He records his location, understood also to be hers, and includes other information about Jane. He uploads. He takes a photo of her. Jane takes a photo of him. They take a photo of both of them. The photos can be in the record. Video of one or both can be in the record. These are entanglements at a higher semantic level than the hash entanglement of the low level blockchain. A Notary can notarise her use of an app at a location. A Notary can be an ATM, taxi, bus, drone. A Notary can be a digital assistant, used by someone who is not the owner, to notarise her location.

### REFERENCES CITED

### Technical Field

The field is the use of mobile devices with a blockchain.

### BACKGROUND

Blockchains have garnered massive attention and investment. Blockchains drive various cybercurrencies, notably Bitcoin and Ethereum and there are numerous others at this time of writing. The key properties of a blockchain are that it is immutable (though new records can be added but not changed) and records can be verified by anyone.

Notaries have been used for centuries to witness the signing of important documents.

### BRIEF DESCRIPTION OF THE DRAWINGS

FIG. 1 shows Jane writing her physical location to a blockchain.

FIG. 2 shows Jane contacting Bob who writes to the blockchain.

FIG. 3 shows Bob and Jane taking photos for the blockchain record.

FIG. 4 shows a notary and a smart contract for a 2 user interaction.

FIG. 5 shows Jane near a digital assistant that she does not own.

FIG. 6 shows Jane scanning a digital assistant screen.

FIG. 7 is a flow chart of Bob notarising Jane's location and app use.

FIG. 8 shows a location-based blockchain with sidechains.

FIG. 9 shows an app-based blockchain with sidechains.

### DETAILED DESCRIPTION OF THE PREFERRED EMBODIMENT

What we claim as new and desire to secure by letters patent is set forth in the following claims.

We will refer to a user having a mobile device. The latter includes cellphones, and specifically smartphones, laptops, tablets, PDAs, Heads Up Devices and Augmented Reality devices.

This submission has the following sections.

### 1: Context;

### 2: Location;

3: Notary devices;

### 4: Reputation (Linket);

### 5: Variants;

6: Performing a task in front of Notary;
7: Notary and private key;
8: Smart home device (digital assistant);
9: Notarising location and app use;

### 10: Sidechains;

10.1: Location-based sidechains;
10.2: App-based sidechains;

1: Context;

In the United States are people known as notary publics, or simply notaries. Bob is a notary. Jane goes to him with a document and some identification of herself. This might be a passport or driver's license. Typically she signs the document and he witnesses her doing this. He puts an official notary stamp on the document, where the stamp is unique to him. He also has a hardcopy ledger or log. In this he writes an entry giving Jane's name, an identity verification (like her passport number or driver's license number) and the date and time. She pays him.

These steps are manual.

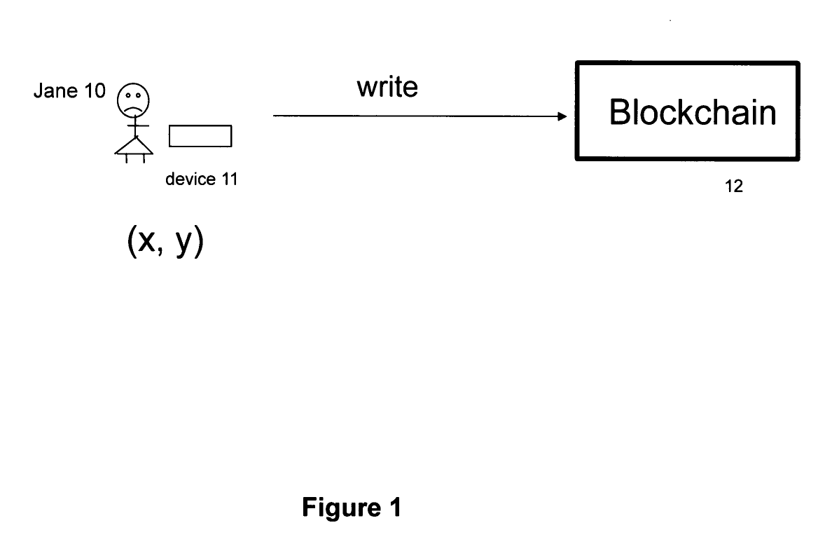

With the advent of blockchains for Bitcoin, Ethereum et al, there have been efforts to use the blockchain's property of being an immutable ledger. See FIG. 1. This shows Jane 10 with her mobile device 11. She uploads some data in a write operation to Blockchain 12.

Often the write operation is of a hash made of her data due to the space constraints of typical blockchain records. But in this submission we will often say that data is ‘written’ to a blockchain, when we mean some hash for the data is actually written.

There have been various startups implementing a notarised blockchain, like blocknotary.com, stampd.io and bitnation.co. Bitcoin itself has what it terms a “Blockchain-based notary [web] page”. These have in common the following—a user Jane employs her electronic device to upload data she has created, like a document or video or audio, and it is written to the blockchain with a timestamp.

2: Location;

See FIG. 1. Consider the case where Jane wants to record her location at a given time. We take the location to be a 2 dimensional coordinate pair of latitude and longitude. This can be easily generalised to adding a third dimension of altitude if needed. If Jane is outdoors her device (especially if it is a cellphone) could use a satellite services like GPS to get her location. Then she executes the actions in FIG. 1.

There is a problem with validating a location. Suppose she wants her location recorded so that at future times, others can use the blockchain to verify her location at that earlier time. But those other people (and Jane) might want stronger proof of her location. A rogue Jane could send false location data. Her phone is in her possession. She can have a program on it that uploads arbitrary locations.

One reason could be occupational. Suppose she is a city guide. She is hired by the city to walk around and offer advice to pedestrians. Often such guides have to check in at various locations during their work. Those check-in locations have gadgets attached to walls. Each gadget can have a different id (signifying each location). She has to scan the gadget with a device she carries. A log is made of her location id and the time. This prevents her from being derelict in her guidance routes. A lazy Jane might not want to walk along all her designated route, but currently the gadgets force Jane to go to each gadget location to check in.

Another job where location verification applies can be where she has to be at different locations in public, to hand out flyers or free samples or to conduct a survey for her employer.

Another reason can be recreational. Imagine an outdoor Augmented Reality (AR) game like Pokemon Go or Ingress. Or a scavenger hunt. She might be required to go to various locations and be able to prove this. If such activities have money prizes, this can be incentive for her to record fake locations.

The blockchain, or any intermediate server between it and Jane, gets a message from her device. The blockchain cannot independently verify location data in the message because she is not in line of sight of a camera device controlled by the blockchain. Put simply, suppose a computer in the blockchain is located in Denver. It gets a message from Jane routed thru the Internet. The message claims she is at the lat-long corresponding to the intersection of Wilshire and Santa Monica Boulevards in Los Angeles. The Denver computer does not control a camera at that LA intersection to verify Jane's claim.

This is a fundamental problem. For guidance to a solution we look at a related problem in the late 1990s. Before Google there were some 14 search engine startups. (All gone now.) A user goes to a search website and types, say, “car”. How does the engine return the most useful results? Most if not all the startups used this approach. They would spider the Web and download pages. In a downloaded page, they would count up the number of times “car” appeared. They would also count instances of the plural form, and of synonyms (“automobile”, “vehicle” . . . ). The pages with the highest count would be returned first in the search results. The flaw was that these pages could be written by those that knew of the counting system, of course. Some authors would do keyword stuffing, where desired keywords were included in parts of the webpage that were not displayed (as in the meta tags). Or even in parts of the webpage that were ostensibly displayed. But these keywords might be in small size or in the same foreground color as the background, and thus invisible to the reader. But “visible” to the search engines that spidered the page.

The fundamental insight of Google's founders was that the importance of a webpage is given by how many other pages from independent websites link to it. They saw the analogy with the university Citation Index. Google is a re-ification of that Index, applied to the web instead of to journal articles.

Make the analogy of a webpage to Jane and her mobile device.

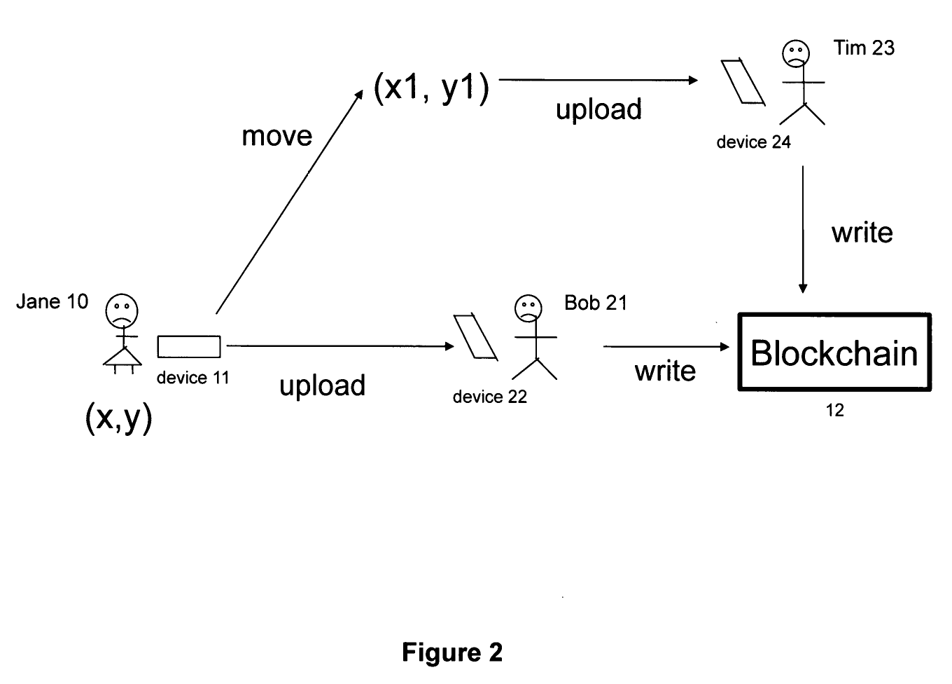

The analog of a second webpage having a link to the (first) webpage is made by including another person. See FIG. 2. Bob 21 and his device 22 are a Notary, in the terminology of this submission. We capitalise this to distinguish from a conventional notary.

Bob can be sitting at a location in a coffeehouse or in a park. He wants to make some money. He has an app that he runs, where he tells the server that he is available to notarise. Jane 10 also has that app. Or perhaps there are 2 different but related apps. One run by the Notary. One run by a client (Jane). The apps would interact via an API. The apps could be written by different companies, with the API being known to both. For simplicity in the following, we refer to one app, but the reader could keep in mind that there could be two. Jane needs her location verified. She uses the app to upload her correct location. The app might returns the locations of nearby Notaries; akin to dating apps. The app might give Bob's first name and other information about him.

Jane picks Bob from the list. (More about this picking later.) The app could have an option that before they physically meet, Jane lets the app tell Bob that “Jane” needs to be notarised. This is akin to ridesharing apps like Uber and Lyft, where the driver and would be passenger are told each other's first names or nicknames.

Or Bob could be at a publicly accessible location (park, coffeehouse) with a sign (perhaps on his clothing or on a table) designating himself as a Notary.

Jane finds Bob's physical location via the app or other wireless means (eg. Bluetooth, RFID). She goes near him. She communicates some data about herself to Bob, along with an offer of various payment methods. The payment can be in a cybercurrency associated with the blockchain. Or it could be in the form of a currency traded on international exchanges, and done via Paypal or Venmo, for example.

The communication from Jane might be done via her device. By showing a barcode on her device screen. Bob's device decodes this. The decoded data could be an URL. His device puts this URL into the data to be sent to the blockchain. Or his device might go to that URL and download some information, which is then put into the data for the blockchain.

Or Jane's device could emit some audio which Bob's device decodes. The decoded information could go into the data to be sent to the blockchain. Or Jane's device might have sent some data to an audio server, which returns an audio signal to her device. The device plays it (a “chirp”). Bob's device decodes the signal and sends it to the audio server, which sends Jane's associated data to Bob's device.

Another method could be where Jane and Bob have a same app on their devices. This app is used for Jane to send Bob data that Bob will notarise to the blockchain.

Jane might pay Bob in a cybercurrency of another blockchain. For example, she could pay him in bitcoins, where the bitcoin blockchain is a different blockchain from the blockchain that the notary application is using. In general, when we say ‘blockchain’ in this application, we refer to non-bitcoin blockchains.

Bob uses the app to write to the blockchain. The information written to the blockchain has his location and the data from Jane and an optional timestamp. Jane uses an app that enables notary service and interaction with a smart contract blockchain that allows notary entries. Note that if Jane sent her data via her app to its server, the server does not have to download this to Bob's app as the data is already available to be entered into the blockchain. Bob needs to only know enough of Jane's data to execute his notary services.

The data written to the blockchain by the app server could include a photo of Jane taken by Bob's device. This could be used as extra authentication of Jane. Bob might charge extra for this.

Or Bob's device might have a compass or some other functionality that gives the compass orientation of the camera in the device. If the device has several cameras (some smartphones have front and back cameras), the camera is that camera which takes the photo of Jane. Bob's device could use this to give his location and Jane's orientation. The latter is used to write to the blockchain.

Further, his device might have some range finding ability. It has the means of giving an approximate distance of the object in front of the camera. Within some maximum distance constraints. Thus his device can use its (x, y) location and the angle and distance to Jane to find her (x, y) location. The latter is written to the blockchain.

Bob's location is not the exact (x, y) of Jane. But she is near him. For many real world applications, this can suffice. For example, Jane might tell Bob to use his location as a proxy for her's. She attests that this suffices for her need for verification.

The information sent to the blockchain has an optional timestamp. Why would we want a second timestamp when the blockchain already writes its authoritative timestamp? It can be that Bob batches these requests from his customers. At the end of the day he commits these in one write to the blockchain. This assumes that the blockchain has the ability to issue signatures (hashes) for each sub-record that corresponds to individual customers like Jane. She will want to ensure that her unique timestamp is associated with her blockchain record to establish both her location and time.

Why is Bob more reliable than Jane to record notary events? Return to the issue of a search engine returning a list of webpages. A page can rank highly if it is pointed to by several other pages that are somehow deemed good. Roughly, a search engine starts with a list of good sites. In the US, these might include the .gov and .mil top level domains. Pages at those domains that have links to outside pages greatly help the latter rise in rank.

Bob can be considered more reliable for several reasons. If he makes money with his service, he jeopardises this if he colludes with a rogue user to issue a fake location. The app company itself might have performed old fashioned physical verification of his identity and background in order to be a registered Notary for the app. His background check could include checking various credit agencies and his social media postings.

How can the blockchain tell that it was Bob who wrote to it? The blockchain could be one where some information is recorded about the writers along with the notary entry. Or the blockchain could be designed so that writing is restricted to a group of users, who might be validated in some manner outside the blockchain.

Returning to the comparison with webpages, see FIG. 2. After interacting with Bob, Jane moves. At some later time she is at (x1, y1) and has to verify her location again. She finds Notary Tim 23 with his device 24. She interacts with him and he writes her data and his location to the blockchain.

In a similar way to how a website can rank highly in search results if it has more links pointing to it from good sites, Jane's credibility can be enhanced if she gets several of her locations vouchsafed by different Notaries.

Put this way. She is purportedly in Denver, say. If she interacts with Bob, who is a Notary in Denver, and a few hours later with Tim, who is another Notary in Denver, this reduces the odds that Jane is really a rogue in Karachi or Lagos.

3: Notary devices;

FIG. 2 depicts Notary Bob 21 with his device 22. A variant is where the Notary is entirely a device. Imagine a modified Automated Teller Machine (mATM), for example. It currently has a camera which records photos of those using it. From a reputational standpoint, the mATM is operated by a bank. Its location is fixed. Jane goes to such an mATM. Perhaps her app when showing the list of Notaries will also show mATMs that are Notaries.

The mATM can have wireless or wired means for her to upload data to it. For example, it could scan a barcode on a screen of her device. The barcode encodes her data. Or the barcode could encode an URL that points to an Internet address with her data. Or the mATM might have an electronic address of itself or the bank, where the address appears on the screen of the mATM or in printed form near it. The address in either case could be shown as text or as a barcode, that Jane's device can scan and decode. Or Jane might be able to use a cable to connect her device to the mATM.

If she has an mATM card (not necessarily from the organization owning the mATM), she might also use that to pay for her notary services. The mATM/bank writes her data, picture and its static location to the blockchain. This blockchain does not need to be one run by the bank owning the mATM.

The mATM might be a conventional ATM with these extra features allowed by software.

A variant is where Jane does not need to pay the mATM for the notary services. She works for an employer that contracts with the blockchain and the bank. The employer wants her to check in her location with either a given mATM or an mATM in some area. She might have to do this several times a day, at the same area or different areas.

As part of the check in process on her device, or soon after this, she uses her device to tell her employer that she has done so. Or perhaps the blockchain can automatically tell her employer when it gets data from an mATM that originated from her.

At the end of her work day Jane goes to an mATM for a final update to the blockchain of her last location. The employer can program the blockchain and authorise the mATM to release cash to Jane as payment for her work. Or the money can be deposited into her bank account or credited to a debit card that she carries (and perhaps inserts into the mATM).

The cash payment from the mATM has utility. Some workers lack bank accounts. They could be paid with a paper check, which they take to a check cashing place that converts it to cash and charges a (large) fee. In this submission, the bank could levy a smaller fee and serve an under-banked section of the community.

Another example is a computer with GPS and a camera outfitted in a taxi. Some taxis already have cameras which take photos of passengers for the driver's safety. In the current context, the passenger can pay for an upload of her data, including her picture, along with the current location of the taxi.

Another example is a bus. New buses in the US now can have 6 or more cameras for safety purposes. Buses also have GPS. These features can be combined so a passenger can ask for a photo to be taken of her. She uploads any associated data to the bus agency's server. The bus uploads her photo and the bus coordinates to the server, which then writes to the blockchain.

As per the previous paragraph, some trains with cameras can also offer a similar service.

Another example is a drone. A user in the open might summon a drone using her phone. The summoning can be by various means external to this submission. The drone takes a photo of the user. She can upload her data and identifier to a server that controls the drone. The photo of her is sent by the drone to the server, which then writes to the blockchain. Unlike earlier examples, this can be a scenario where she summons a notary instead of going to one.

4: Reputation (Linket);

When Jane searches her device for a list of nearby Notaries, each Notary could list its services and the prices it charges. Important additional information could be about any reputation a Notary has. There might be a server, like what Yelp does for restaurants or what other websites do that rank teachers and tutors. The app used by Jane might access those servers to display a Notary's rating and any reviews he has.

A high ranking Notary could charge more.

The picking of a Notary can be done manually by Jane. Though she might set criteria like a minimum rating for a Notary or a maximum cost to simplify what she has to review before picking a Notary. Going further, the picking could be automated on her device. If her criteria gives several Notaries, there could be a final criterion, like find the closest.

But just as a user could pick a Notary based on his reputation, a Notary might want to be able to pick a customer based on her's. The Notary server could show any data it has on Jane's past use of the service. And possibly what it knows about her activities and presence on the Internet.

A Notary might have a Linket™ This is a label associated with a mobile user and a mobile app. It is a brand owned by a user for personal or professional purposes. We have several US patents pending and 1 US patent (at this time of writing) on linket. A linket is a Unicode string, akin to a domain name. There is a linket Registry. Given a linket, it returns a deep link. The latter is a combination of an app identifier (the app is in a mobile app store) and an identifier of a network address.

Essentially a user with a mobile device sees a linket as a clickable link in, for example, her mobile browser. The linket points to its owner's presence in a specific app. The user clicks the linket. Her device looks up the linket in the Registry and gets the deep link. Her device installs the app if it is not already present, and runs it with the network address as input. The app boots up and contacts the address. At that address, the linket owner has a program, which might be another instance of the app, listening at a port for such a query from a user. The linket owner can be using a mobile device, so his network address changes often. A point is that his brand remains constant, while his deep link might change. The linket Registry can let users of a linket rate and review the linket owner.

When Jane uses her app to search for nearby Notaries, it can check if a Notary has a linket. If so, it gets the Notary's linket rating and can show that or use as a qualifier in deciding whether to show the Notary to Jane as a possible choice.

5: Variants;

Previously we described how Jane, an arbitrary user, gets a Notary to write her location (or a close approximation) and other data of hers to the blockchain.

Bob was described as possibly taking a photo of Jane. This photo is entered into the data that is to be hashed, with the hash going into the blockchain. Given the ease of taking photos, Bob might take several photos of Jane, possibly against the surroundings, to add verisimilitude to his attesting to her presence near him. Some photos might be of both of them. He takes a selfie of himself and she is next to him in the photo, further substantiating their entanglement and providing proof.

Likewise Jane can take a photo (or several) of Bob. And she might take a selfie of her with him in the photo. Her photos can be sent to him, perhaps via a common app that they are using. He can add her photos to the data to be hashed.

Photos in the data can have associated information designating who took each photo.

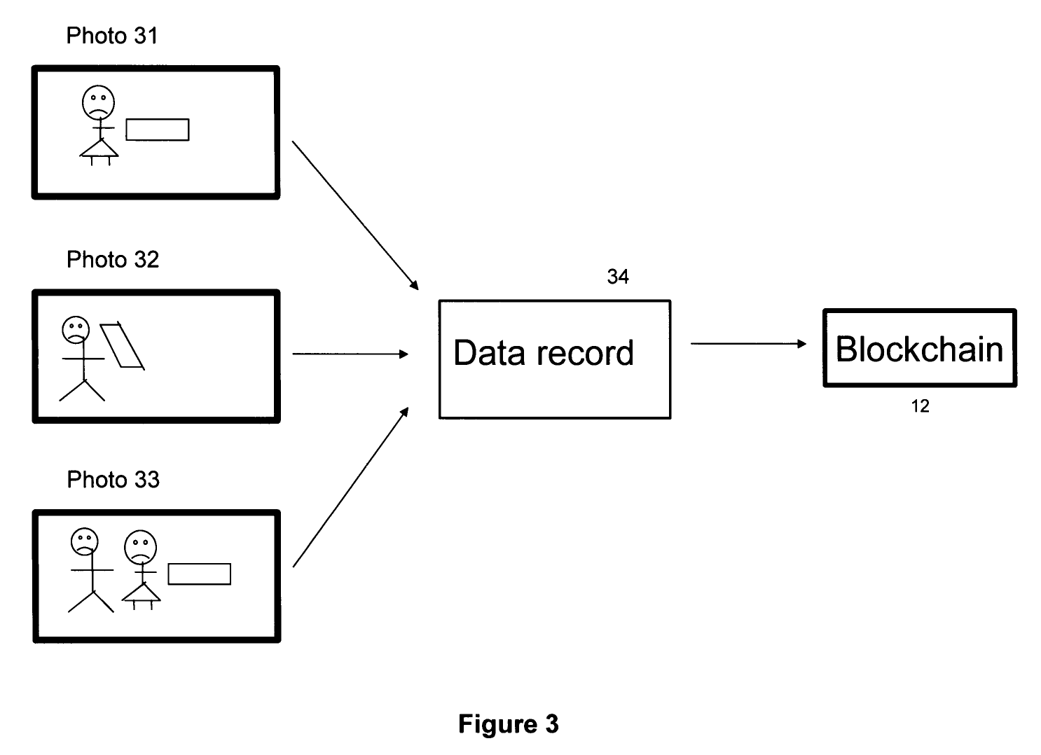

See FIG. 3. Photo 31 is a photo of Jane taken by Bob. Photo 32 is a photo of Bob taken by Jane. Photo 33 is a photo of both of them, taken by one of them. These are submitted to data record 34. Typically the submission is done by Bob. The figure depicts the data record then uploaded to the blockchain 12. Typically the actual data record would be stored outside the blockchain, while a hash of the data record is entered or used to make an actual record going into the blockchain.

The reader is acquainted with the general properties of blockchains. One key property is that in its simplest form, 2 adjacent records in the blockchain are hashed. This binds the records. (By induction, this is continued to bind all the records.) The hashing is a mathematical means of deliberately entangling the records. The above taking of photos by the user and the Notary of each other, and especially photos of both of them together can be understood as another form of entangling, at a higher semantic level.

These entanglements of 2 humans in the same photos are a response to expected advances in image editing. A rogue Jane who is able to “validate” her position to a blockchain might include photos or video mocked up to falsely show her in various locations. Our countermeasure is to use a trusted human Notary with an accompanying device.

A different take can be seen by comparing with Ethereum's “smart contracts”, which Ethereum considers to be its core advantage. The above image entanglements are implicit smart contracts. The user Jane and the Notary Bob (and their devices) perform certain actions that might be contractually required for the uploading of a record to the blockchain.

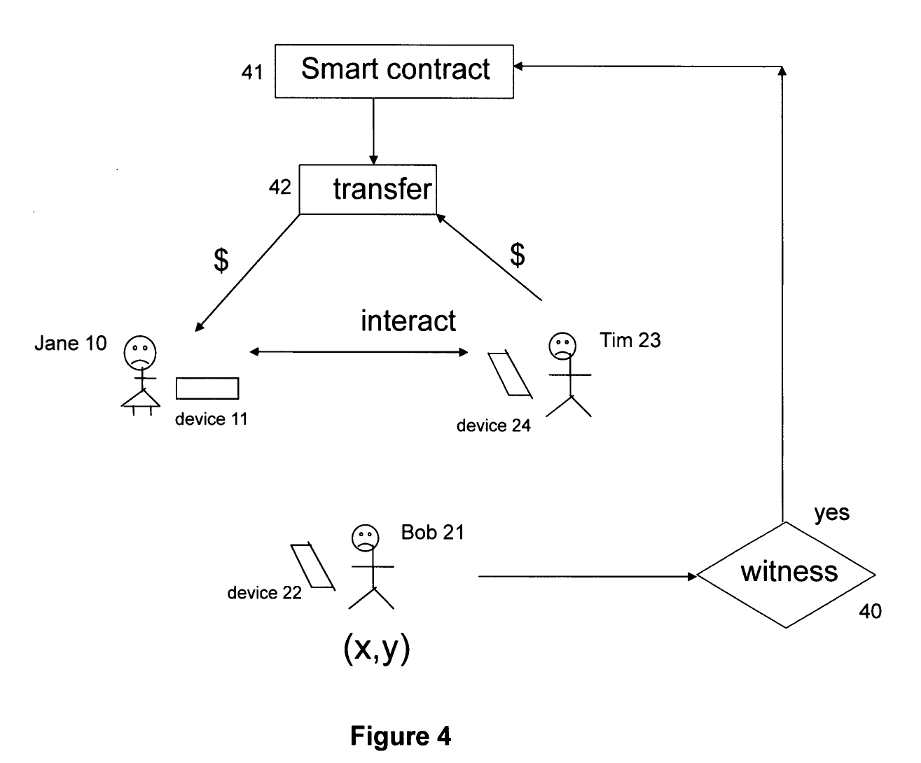

There can be a use of a Notary with a smart contract that does not need to involve a blockchain. See FIG. 4. The smart contract 41 can be considered to be a device that holds funds in escrow. The money comes from one party, Tim 23. He expects to interact with Jane 10. Perhaps he is buying a good from her. They will be at or near a location (x, y). Or perhaps they are already there. She wants to get paid. But perhaps in part because they are strangers, she is unsure that Tim will do so. Tim puts the money in escrow with the smart contract. (The money is in electronic form.) Jane uses her device 11 to interact with the smart contract to verify this. But there is still the problem that if the interaction is completed, Tim might refuse to release the funds.

Bob 21 with his device 22 is at (x, y). He is the human interface between Jane and Tim and the smart contract. He witnesses their interaction. In part, he might act as a safety factor for one or both of them. If the interaction is done to his satisfaction, Bob uses his device to attest via a program “witness” 40 that connects to the smart contract. This attesting can or might not involve Bob uploading his location to the smart contract. He acts as a notary or referee. The smart contract releases the funds in the step transfer 42 to Jane.

Item 42 is likely not a separate device, but a process step. It could involve the smart contract interacting with, say, an established financial party like Paypal or a bank, which would actually hold the money in electronic form.

There are minor steps where Jane goes to the smart contract in the final stage, to get the funds. But it is now straightforward for the mechanics of electronic funds transfer to or from a person.

A variant of FIG. 4 is where there is no Tim. In earlier sections we described how Jane goes near Bob and he notarises her location (and other data) to a blockchain. Now the smart contract she is interacting with might require her to verify her location (and perhaps other data) to Bob. He does so, telling the smart contract. It can then release funds or do other actions on Jane's behalf.

The smart contract would likely record the interaction in some database. But it does not need to write to a blockchain ledger.

Another variant is to consider 2 Notaries, Bob and Daisy. Perhaps Daisy is more experienced than Bob. She might have a ranking higher than him in some ranking of Notaries, for example. Bob might ask Daisy if she is near him, or if he finds her by whatever means, to notarise him from her location. He acts as Jane in the earlier sections, as a recipient of Notary verification. Daisy having done so for Bob, he then acts on his own as a Notary.

Thus there can be a chain of notary links. Regard a person with a mobile device as analogous to a webpage, and a Notary as making the equivalent of an URL when it notarises her. Then this act of a Notary notarising another Notary is readily seen as a webpage linking to another webpage.

Another method is device verification. When Bob notarises Jane, he could first send a verification signal to her device. Jane then shows the signal on her device screen to him. This proves that Jane can operate the device. It is not stolen and the screen is locked to her, for example. If she cannot show this, he might decline to notarise her. If he takes photos of her, one photo could show her and the signal on her device screen. The signal might be a barcode or plain text. The text might be her name. Maybe also his name, especially if the photo is of both of them.

The signal Bob sends might be played as audio on her device. So that he can hear it.

Related to this, Bob might take a short video of her. The video includes the audio that he sent her. The video could also include her speaking.

The use of Jane in a video offers more data about her presence and identity.

Thus far Notary Bob notarises only 1 user at a time. He could notarise several users involved in a common activity who approach him as a group.

6: Performing a task in front of Notary;

Jane is in Bob's Line of Sight (LoS) for some duration. Perhaps she has to perform some task in public. Like ask people questions for a survey. Or hand out flyers. She goes to Bob at the start of the task and explains her need for him to observe and notarise her doing the task. She then begins her task near him. During the task, Jane remains in Bob's LoS. He observes her activity. At the end of the task she goes to him with a summary of her task and accomplishments. This summary might be in an electronic message she sends to him. He concurs that he observed her doing the task. He uploads the summary and his or her position and the start and duration of the task to the blockchain.

A minor caveat to the previous steps is that perhaps for extended duration tasks, she might temporarily step out of Bob's LoS to go to the toilet.

Related is where Bob notarises Jane handing something to another person, Tim. She might be a courier. Jane and Tim do the handoff in front of Bob, who takes a photo or video of the interaction. The recording can show clearly visible the object being transferred, and the location and time where and when the transfer occurred.

If this is video, the video could contain audio spoken by Jane. It could also have audio spoken by Tim.

7: Notary and private key;

When Bob uploads Jane's position and related data to the blockchain, he can also make and sign an electronic document and send it to her. The document can have his name and electronic addresses and her location. It can also assert that he notarised her location and other data with a blockchain. It can say which blockchain, because in general there might be several blockchains for which he could have uploaded to. He signs the message with his private key.

Jane can take this document from Bob and show others as validation. They can use his public key to verify that the message was from Bob.

The document can also say—a) how many photos Bob took of her; b) how many photos Jane took of Bob; c) how many photos they are both in.

The document might also include some or all of these photos.

The document could be in the form of a publicly accessible webpage written by Bob. He sends the URL of it to Jane and she can forward it to others who need to know of her activities.

8: Smart home device (digital assistant);

Recently companies like Amazon have released smart home devices or digital assistants or virtual assistants, like the Echo™ and Spot™. These are non-mobile devices connected to the Internet, usually by wired means, like Ethernet. Users might interact by speaking to the device as they are in the same room as the device. Some devices could have a camera or a screen.

The server that the assistant is connected to might regard the assistant as reliable. In this application, the assistant could be used as a Notary. It is assumed that the server knows the assistant location. This does not require the assistant to have GPS. How the server knows the location is outside the scope of the application. There could be an initial setup where the owner of the assistant communicates with the server and tells the server the assistant location, for example. The owner could give her home or office address, and the server uses a mapping database to get the location.

In this section, we will refer to the digital assistant and to its server. Note that some actions that we describe as done by the server might be done by the assistant. Or vice versa.

It is assumed that the digital assistant can detect known users. These users might include the owner. The detection could be done via the assistant getting a code from a user. The user had at some earlier time defined herself to the assistant. And perhaps the assistant also uses voice recognition to detect the voice signature of a known user, in addition to or separate from the use of a code (password). Thus a known user, Jane, could identify herself to the assistant and thus to the server. The server can use the assistant location and some identifier of Jane and any ancillary data to write to a blockchain.

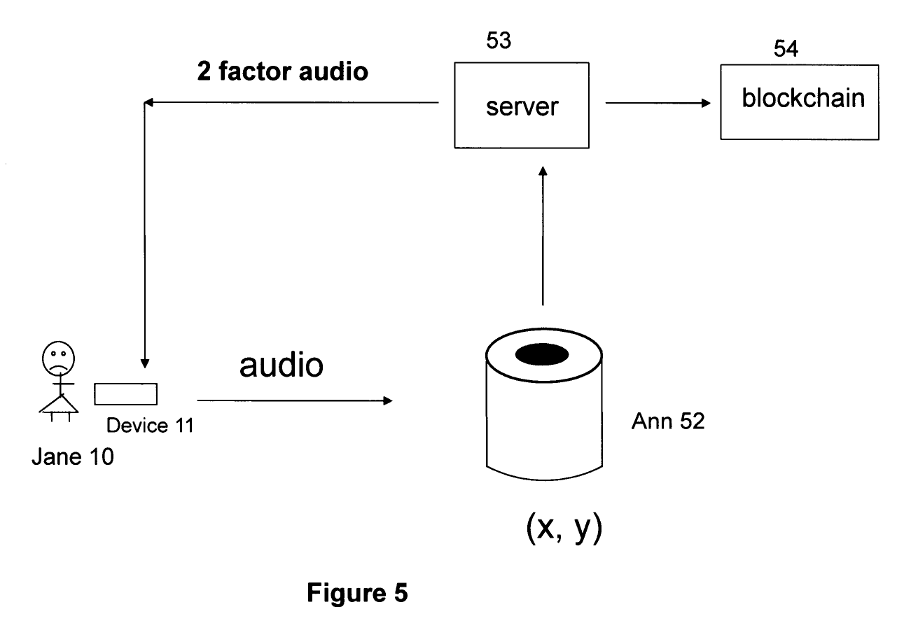

See FIG. 5. It shows Jane 10 with her mobile device 11 near assistant Ann 52. The latter talks to server 53. The server writes to blockchain 12. The (x, y) label is the location of Ann 52.

One variant is that the firm running the server also runs a blockchain. So the server and the blockchain are tightly integrated for optimal performance.

Another variant is to realise that the server is the server for many digital assistants deployed at various homes (and possibly offices). Some assistants could also be in publicly accessible places like a library or cafe. Suppose Jane is the owner of a given assistant at her home or office. The server can recognise her at that location. But she might travel to another place, like a friend's home, or another office, where there is a second instance of the assistant. The server might let Jane be able to login from this atypical (for her) assistant. Thus Jane can use this second assistant to authenticate her location, being that of the second assistant.

For Ann 52 to notarise Jane 10 via audio, Ann and its server can do one or more of these 3 actions:

A] Jane speaks and Ann uses the audio as a voice print, to match against server 53's record of Jane's earlier voice made when Jane was at home at a different digital assistant. The latter is not shown in FIG. 5, for simplicity. It has to be stressed that in FIG. 5, Jane is not at home. She is a visitor at the location of digital assistant Ann.

B] Ann speaks and asks Jane a personally contextual question or asks for Jane's password. The question could be about something from content that Jane had conversed with her assistant at Jane's home or office. Server 53 has access to such data.

Ann could say a phrase and ask Jane to repeat it. Where Jane's assistant knows that Jane had never used this phrase in conversation before. Server 53 gets data from Jane's assistant, so Ann can use this to determine a phrase. This aims to prevent a replay attack where somehow an attacker had recorded Jane's earlier speech at her home.

C] Ann asks Jane if Jane has her mobile device 11 with her. If Jane says yes, Server 53 sends an audio file in an electronic message to mobile device 11. This is designated by the label ‘2 factor audio’ on the arrow going from server 53 to device 11. Jane tells her mobile device to play the audio. Or device 11 might automatically play the audio. Ann records the audio and sends it to the server for comparison with the original audio.

The 2 factor test is extra validation of Jane's identity. If the Jane in front of Ann is the real Jane, then she (Jane) has the mobile device that she had earlier told the server about when she was in front of her own assistant device at home. So the server here tests that Jane has possession and control of her mobile device.

The reader should understand that the 2 factor mechanism is not infallible. But it acts as an easy barrier to implement against simple spoofing.

In FIG. 5, the directions of the arrows are not meant to exclude cases where data flows in the opposite direction. The arrows are an aid to the reader, to indicate the default data flows. Also, the label ‘audio’ over the arrow going from Jane and device 11 means audio that comes from Jane speaking or from device 11, to be captured by Ann. Typically the audio from Jane and the audio from device 11 will not overlap much if at all.

If Ann has a camera, she can use this to take photos of Jane (as in earlier sections). The photos can be used as part of the data that goes into the blockchain. Or, as said repeatedly before, the data is hashed and the hash goes into the blockchain.

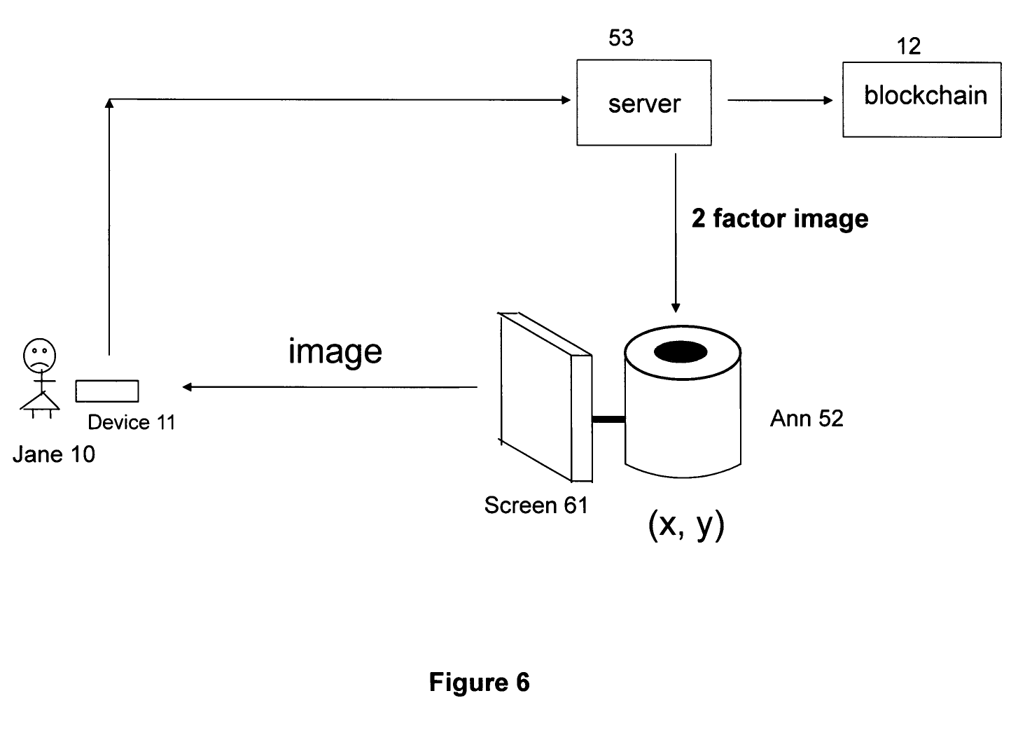

Now suppose Ann 52 controls a screen. See FIG. 6 with Screen 61 attached to or part of Ann 52. If Jane's mobile device 11 has a camera, then a 2 factor image test can be done, similar to the above 2 factor audio test. Here in FIG. 6, server 53 sends a 2 factor image to Ann 52, which shows it on Screen 61. Ann can also play audio on her speaker, to tell nearby Jane to take a photo of Screen 61. Jane does this. Ann tells Jane to upload it to server 53, where by assumption Jane already has an account. The server can use image recognition to extract the image of Screen 61 in Jane's photo, and to compare with the original image it sent Ann.

In general, the server should make a unique image to send Ann, to reduce chances of a replay attack by someone who somehow copies an earlier test image either from this particular Ann or from another digital assistant controlled by the server.

The reader can compare FIGS. 5 and 6 to see the common idea. To test that there is a real person in front of digital assistant Ann.

Another possibility arises when digital assistant Ann controls a screen. The server sends a unique image to the screen. Ann tells Jane to take a selfie of Jane near Ann, with Ann and her screen in the photo. This is an entanglement of the user with the digital assistant. The unique image can act in part as equivalent to a timestamp. Because otherwise the digital assistant might look the same in a photo. The selfie photo can be part of the data Jane uploads to the server and thence to the blockchain.

If Jane is a known user to the server, Jane and an instance of the assistant acting as an ad hoc Notary can notarise Tim 23, who does not have an account at the server. Tim is near Jane. Tim might have some data about himself, in addition to the use of Ann's location data, that goes into the blockchain. Suppose Tim has a mobile device with that data. Various means can be implemented to transmit that data to the assistant and thence to the server. For example, Jane can be assumed to have a mobile device. And Jane is already assumed to be known to the server. If Tim and Jane already have each other's electronic address, like for email, then Tim can send his information to Jane's address. Her mobile device can then forward this to the server. If the server knows Jane, it can be expected that she has a means to communicate with it (eg. email) separate from talking to the assistant.

Or Tim can transfer his data wirelessly to Jane via showing a barcode on his screen, which she scans with her device camera and decodes. Another way is to use his device to play audio encoding an address of his data at an audio server. Jane's device decodes the audio and gets the data from the audio server. Or Tim sends his data to a collision server. They touch their devices. Her device gets the data from the collision server.

Federation is another capability possible with the use of digital assistants.

Imagine that Jane at her home or office used an Amazon Echo assistant. Jane is known to the Amazon server. Jane goes to another location where there is a Google Home assistant. But she is unknown to Google's assistant server. Amazon and Google can have a federation interaction. Jane tells the Google device that she has an Amazon assistant device. The Google server contacts the Amazon server. The Google assistant then acts as an intermediary. Analogous to how a user with a bank debit or credit card can use it at ATMs of other banks.

In the current case, if Jane wants the Google assistant to notarise her location, the writing of it (and associated data) to the blockchain can be done by either the Google or Amazon server.

One utility of this section is that it expands the versatility of digital assistants beyond the household that owns a digital assistant. It allows the possibility for a digital assistant to be placed in locations like malls and coffeehouses and libraries. Related to this is server 53 making the locations of publicly accessible assistants available on the network. So a user can use her mobile device to find nearby assistants to notarise her location.

FIGS. 5 and 6 show the server writing to a blockchain. A variant is where the digital assistant can directly write to the blockchain. Some data to be used in the writing might come from the server. A merit of having the assistant do the writing is that this could reduce some of the workload on the server.

Another variant is to consider FIG. 5. Suppose Jane logs into the server by talking to Ann or using Jane's device 11. The server knows Jane's electronic address. It can send this to Ann. She might make a 2 factor audio and send it to Jane's address, and then record device 11 doing the playback. This also reduces workload on the server. An extra benefit is that it can improve the user experience for Jane. The latency (delay) from Ann sending the audio via the network should be much less than that from a possibly distant server doing so.

9: Notarising location and app use;

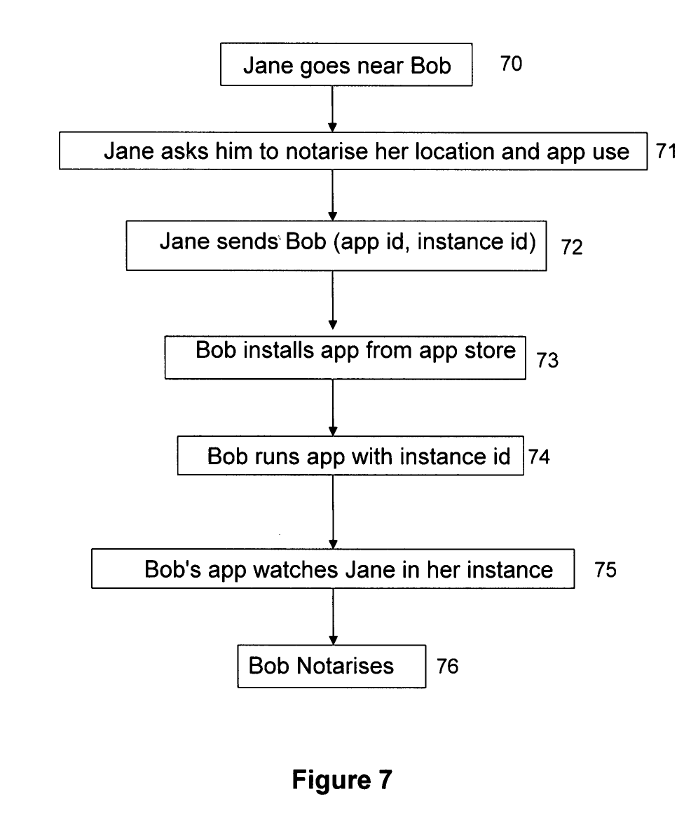

Earlier sections described how Bob might notarise Jane's location and that he saw her do certain activities in public near him. This section describes how he can notarise her use of an app (near him) as well as her location. See FIG. 7. It is a flow chart. Step 70 is Jane being in proximity to Bob.

Step 71 is Jane asking him to notarise her location and app use. Perhaps she is using an Augmented Reality (AR) app (which might be for a game) in public. In general Jane and Bob are strangers. They are not expected to know each other's names or electronic addresses. The latter include phone numbers, email addresses and Twitter or Instagram handles.

The manual approach is that she shows him her phone screen, on which is running some app. She tells him its name. He can then manually write the app name into a document along with her location, and this goes to the blockchain. While possible, this can be very clumsy and error prone for Bob.

More stringent technological (machine) steps are available. In part because when she showed him an app on her screen, he does not know that the image is that of the actual purported app. Perhaps it is an app he has never heard of. Or if it is a well known app, she might be running a fake version (simulation).

Step 72 is Jane sending Bob an app id and an instance id. This can be done by various wireless means. She might convert the data into a barcode and show it on her screen. Bob scans with his device camera and his device decodes the image. Or Jane could convert her data into an audio signal and her device plays this. Bob's device decodes the audio file to get the data. This might be done via Bergel's “Chirp” invention. Or Jane and Bob could use a collision server. She uploads the data to that server. They collide their devices. Bob's device downloads the data from the server.

One of us (Boudville) has a US patent pending, “Barcode, sound and collision for a unified user interaction” 20150113068, that describes the 3 wireless mechanisms in more detail.

The app id is the id of the app in an app store. By “app store” we mean any server that holds executable copies of apps for mobile devices, that are meant for download. It is not restricted to the Apple App Store.

There might be an extra “store id”, to designate between various app stores. Or a “device id” to designate a given hardware platform. For simplicity these are omitted from FIG. 7.

The instance id can be the id of an instance of the app that Jane is running. In general an app that has several simultaneous users might in its app server hold several instances in separate memory areas. Each area has an instance id. One of those areas is Jane's instance.

Or the instance id can be considered as a character id in some cases. Imagine a Massive Multiplayer Online (MMO) game. The game server might put all those players into one large game instance. So there is only one instance running at any time. But within that instance, each player is assigned a character id of her character. Jane's app could use either the app id or instance id.

Step 73 is Bob using the app id he got from Jane to install the app from an app store. Note that the app store is considered to be reliable, like those from Apple, Google, Amazon, Nokia and Microsoft. In general, before any such install, his device would check to see if the app is already present, obviating any new install.

Step 74 is Bob's device running the app with the instance id as input. This puts Bob into Jane's instance of the app as an observer. It is assumed that the app has been modified by its owner to permit this mode of operation.

Or if the instance id is actually Jane's character id in (eg) an MMO game, Bob's app is put into the MMO as an observer located in the game space near her.

In either case, Bob is in the same app as Jane and he can watch her to confirm that she was active in that app. Step 76 is where he Notarises her real world location and (eg) the app id and possibly the instance id. The meaning of the latter 2 parameters is that of this section.

Bob does not need to manually type the app and instance ids into whatever document gets hashed for the blockchain. There can be software on his device to do this.

An extension of Bob watching Jane in the app is where she performs certain actions (eg. catch monsters). He can notarise that he witnessed the actions.

10: Sidechains;

Sidechains have been proposed as a variant of blockchains. One reason is to reduce the amount of computations needed to add a record to the blockchain. The sidechains can also reduce the computations needed to verify records. A person interested only in the topic of a given sidechain need only do the hashing for the records of that sidechain.

This speeds up the number of transactions per second that a blockchain can handle; to make it competitive with traditional databases. Another reason is to reduce the amount of energy lost as heat during the computations. A concern is that if blockchains become widely used, they could contribute excessively to global warming.

10.1: Location-based sidechains;

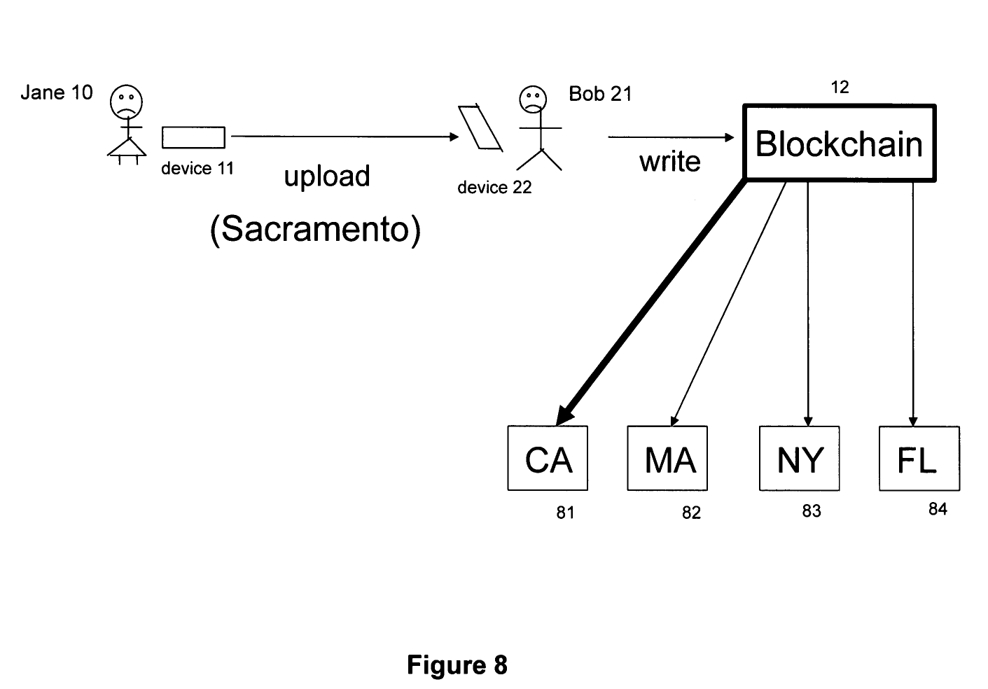

Consider FIG. 8. Blockchain 12 is assumed to have location-based sidechains. Several are shown. Item 81 is a sidechain for California. Item 82 is a sidechain for Massachusetts. Item 83 is a sidechain for New York. Item 84 is a sidechain for Florida. When blockchain 12 gets a record to be added to a sidechain, there is some geographic information in the record that lets the blockchain decide which sidechain to forward it to.

The sidechains might be considered part of the blockchain. FIG. 8 shows the sidechains as separate for the purposes of explanation. Essentially the blockchain 12 item acts as a controller of the overall blockchain.

Now suppose that Jane 10 is near Bob 21 in Sacramento, Calif. The label “(Sacramento)” is shown in FIG. 8. In practice, it is likely that a (lat, long) coordinate pair will be used. But we use the label “(Sacramento)” as more meaningful in the figure. Bob acts as Notary and writes the record to blockchain 12. The blockchain can easily map the (lat, long) to being inside California. There are long established methods in Geographic Information Systems that can define the geofences of the American states used in this example, and that can find which state (geofence) a given (lat, long) is in.

The blockchain routes the record to CA 81, as suggested by the thick black line from item 12 to item 81.

Thus location-based sidechains can naturally accommodate records that contain location information. No impedance mismatch.

An edge case (literally) is when an interaction and the resulting record refer to a location on the border of 2 regions, each with its own sidechain. The blockchain can have some method to decide which sidechain gets the record. A related case is where the interaction crosses 2 regions. Imagine a ridesharing interaction where a passenger is driven from Sacramento in California to Las Vegas in Nevada. The blockchain can decide which regional sidechain (or perhaps both) gets the record.

10.2: App-based sidechains;

A different situation arises when the sidechains are based on a functional classification of (mobile) apps. For example, mobile apps could be divided into such classes as games, dating, finance, news etc. And the games class might be divided into subclasses like AR, turn based, strategy etc. Note that for the examples given here, the classes or subclasses may or may not be mutually exclusive. A given app could be both gaming and dating, for example.

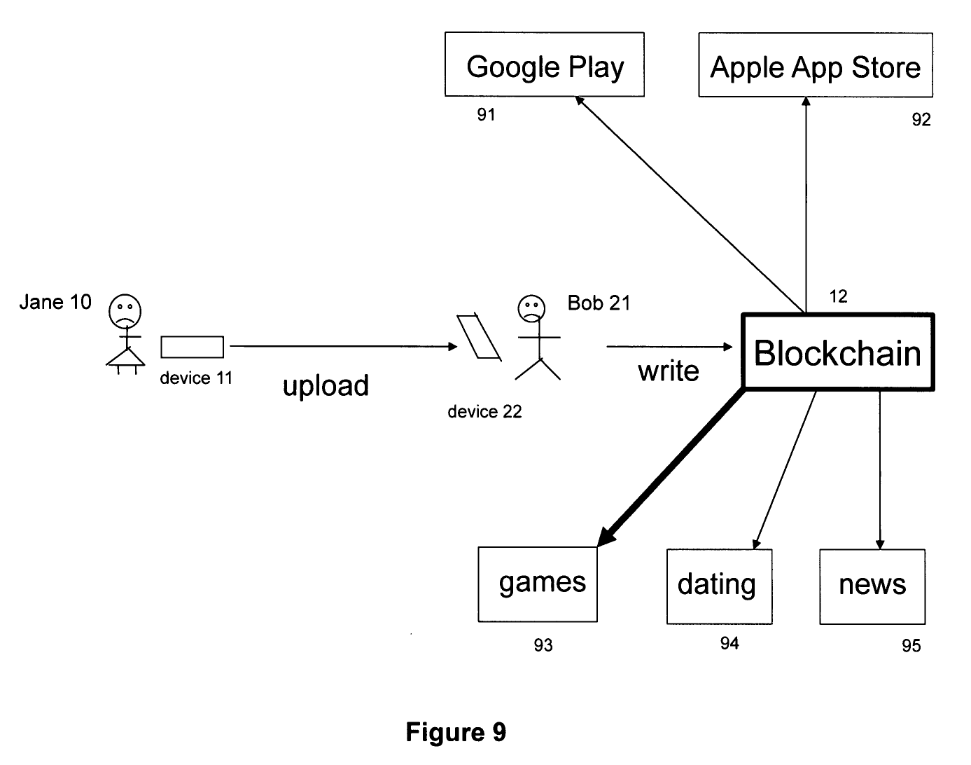

See FIG. 9. It shows blockchain 12 with games 93 sidechain, dating 94 sidechain and news 95 sidechain. There could be more sidechains. Blockchain 12 also uses third party app stores. Two are depicted—Google Play 91 and Apple App Store 92. These are currently the major app stores for mobile devices. Jane 10 interacts with Bob 21 using their mobile devices. Bob uploads a record to the blockchain. The record has some identifier of the app used by Jane on her device 11. The blockchain uses this identifier to query one or more app stores. If the identifer has a subidentifier that designates a given app store, then the blockchain need only ask that app store.

From the app stores, the blockchain finds information about the app. When an app store accepts an app to put into its database, it requires the app firm to write an accurate description of the app. This helps the app store classify the app. The blockchain gets the classification of the app. This aids the blockchain in deciding which sidechain to send the record to.

In FIG. 9, an assumption is that Jane is using a game app. This leads the blockchain to allocate the record to the game sidechain, as suggested by the thick line going from the blockchain to that sidechain.

The data record sent by Bob about Jane need not have any location information.

The use of app-based sidechains can be combined with that of location-based sidechains. This is a straightforward extension of the discussion.

We claim:

1: A method of a first device Alpha, controlled by a first user, interacting with a second device Beta carried by a second user; Alpha in proximity to Beta; Alpha receiving data from Beta; the data having identifying information about the second user; Alpha adding location information to the data; the location being the location of Alpha or an estimate of the location of Beta; Alpha adding identifying information about the first user to the data; Alpha uploading the data to a blockchain.

2: The method of claim 1, where Alpha receives payment from Beta.

3: The method of claim 2, where the payment is in a cybercurrency.

4: The method of claim 1, where Alpha has a compass; Alpha uses the compass to find an azimuth of the second user with respect to north; Alpha estimates a location of the second user using the location of Alpha and the azimuth of the second user.

5: The method of claim 1, where Alpha has a camera; Alpha takes one or more photos of the second user; the photos are added to the data to be uploaded to the blockchain.

6: The method of claim 5, where a photo taken by Alpha shows the first user and the second user.

7: The method of claim 5, where Alpha receives one or more photos from Beta; the receiving being via a common app run by both devices; a photo from Beta shows the first user; Alpha adds the photos from Beta to the data to be sent to the blockchain.

8: The method of claim 7 where a photo from Beta shows the first user and the second user.

9: The method of claim 5, where Alpha takes a video of Beta and the second user; the video is added to the data to be sent to the blockchain.

10: The method of claim 9, where the video includes audio spoken by the second user.

11: The method of claim 5, where Alpha takes a photo or video of the second user interacting with a third user; the photo or video is added to the data to be sent to the blockchain.

12: The method of claim 11, where the interaction between the second and third users includes an item being transferred between them; the photo or video showing the item.

13: The method of claim 11, where Alpha takes video; the video includes audio spoken by the second user and audio spoken by the third user.

14: The method of claim 1, where Alpha receives data from Beta by scanning a barcode on a screen of Beta; Alpha decodes the barcode to an Universal Resource Locator (URL); Alpha puts the URL into the data to be uploaded to the blockchain.

15: The method of claim 1, where Alpha decodes audio emitted by Beta; the decoded information being put into the data to be uploaded to the blockchain.

16: The method of claim 1, where Alpha sends a signal to an electronic address of Beta; Beta displays the signal on a screen of Beta; Alpha takes a photo of the screen of Beta; Alpha decodes the photo and compares the decoded information to the signal sent to Beta; if identical, Alpha uploads data to the blockchain.

17: The method of claim 1, where Alpha sends an audio signal to an electronic address of Beta; Beta plays the audio; Alpha decodes the audio from Beta; Alpha compares the decoded information to the audio sent to Beta; if identical, Alpha uploads data to the blockchain.

18: The method of claim 1, where the receiving of data by Alpha from Beta is via a common app run by both devices.

19: A method of an Automated Teller Machine (ATM) interacting with a device Beta carried by a user; the user in line of sight of a camera operated by the ATM; the ATM receiving data from Beta by a) scanning a barcode on a screen of Beta, or b) the ATM showing an address of the ATM on a screen, Beta having a camera, Beta scanning the address and communicating with the ATM; the data having information about the user; the ATM adding a location of the ATM to the data; the ATM making and adding one or more photos of the user to the data; the ATM adding information about the ATM to the data; the ATM uploading the data to a blockchain; the ATM informing an employer of the user.

20: The method of claim 19, where the ATM receives authorization from the employer to make a payment to the user; the ATM makes the payment.
